(19) United States
(12) Patent Application Publication
(10) Pub. No.: US 2019/0339768 A1
(43) Pub. Date: Nov. 7, 2019

(54) VIRTUAL REALITY INTERACTION SYSTEM AND METHOD

(71) Applicant: GUANGDONG VIRTUAL REALITY TECHNOLOGY CO., LTD., Guangzhou City (CN)

(72) Inventors: Jie He, Guangzhou City (CN); Jingwen Dai, Guangzhou City (CN)

(21) Appl. No.: 16/513,736

(22) Filed: Jul. 17, 2019

Related U.S. Application Data
(63) Continuation of application No. PCT/CN2017/072107, filed on Jan. 22, 2017.

(51) Int. Cl. G06F 3/01; H04N 13/239; G06F 3/0346; G06F 3/03

(52) U.S. Cl. CPC G06F 3/012; G06F 3/0304; G06F 3/0346; H04N 13/239

(57) ABSTRACT

A system for interacting with a virtual reality environment is disclosed. The system comprising: one or more input controllers, configured to interacted with the virtual reality environment; a wearable integrated device, configured to be worn by a user of the virtual reality environment, and integrate a mobile device running the virtual reality environment; and a binocular camera, configured to be disposed remotely from the one or more input controllers and the wearable integrated device, capture a first image of a three-dimensional space including the one or more input controllers and the wearable integrated device and a second image of the three-dimensional space including the one or more input controllers and the wearable integrated device, preprocess the first image and the second image to obtain data, wherein, the user's interaction with the virtual reality environment is calculated according to the data obtained by preprocessing.

### CROSS-REFERENCE TO RELATED APPLICATIONS

This application is a continuation application of International Application No. PCT/CN2017/072107, filed on Jan. 22, 2017, the disclosure of which is herein incorporated by reference in its entirety.

### TECHNICAL FIELD

The present disclosure relates to field of virtual reality, and in particular, to a virtual reality system and method.

### BACKGROUND

With the development of virtual reality technology, it has become a tendency for users to experience the virtual reality environment by wearing Head Mounted Display (HMD). In addition to the simple passive experience, virtual reality games have also been developed, users can provide input signals to virtual reality games via a variety of input means, thus, users can interact with the virtual reality games to enjoy the game with the input means In virtual reality technology, it is a basic technology to track the input signal source so that the user can interact with the virtual reality environment according to their viewpoint and location in the virtual reality environment.

In traditional interaction technique of virtual reality, an infrared light source is usually used as a trackable signal source. The infrared light source is placed on the user's hand-held control device, and the signal source is captured by an infrared light imaging device. In this scheme, although the infrared signal can effectively improve the signal-to-noise ratio and provide higher precision tracking resolution, since the infrared signal is a single feature, it is difficult to distinguish the identities of these different signal sources when there are multiple infrared signal sources in the system.

In another technical solution, the contour of user's hand is scanned by optical structure signals to identify the changes of palm posture or finger position. The solution may include the following steps. Different image processing methods are used to process images, and specific features are used as gestures to find palms in the images, the static gesture image can be found from the images, and then compared with the specific gesture image in the database. The successful identification of the solution depends on whether the gesture contour can be accurately cut out from the images or the line features of the gesture contour can be extracted. However, the cutting gesture contour and extraction line features are often affected by background, light source and shadow factors. Meanwhile, the cutting gesture contour is affected by the distance between the hand and the image camera and the change of the hand's own posture. In addition, in order to improve the recognition rate, it is necessary to establish a large number of preset gesture databases for comparison or increase error tolerance.

### SUMMARY OF THE DISCLOSURE

An improved system for interacting with a virtual reality environment is provided in embodiments of the present disclosure, which can be used in combination with components of an existing virtual reality system, thus further reducing the cost of experiencing the virtual reality technology.

According to one aspect of the present disclosure, a system for interacting within a virtual reality environment is provided. The system includes one or more input controllers, a wearable integrated device, and a binocular camera. The one or more input controllers is configured to interact within the virtual reality environment, and the input controller includes a first signal emitting unit that emits a first signal. The wearable integrated device can be worn by a user, and integrate a mobile device running the virtual reality environment. The wearable integrated device includes a second signal emitting unit that emits a second signal, a signal receiving unit that receives data transmitted to the wearable integrated device;, and a communication unit that transmits the data, received by the signal receiving unit, to the mobile device. The binocular camera is disposed apart from the one or more input controllers and the wearable integrated device. The binocular camera includes a left camera, a right camera, an image processing unit and a communication unit. The left camera is configured to capture a first image of a three-dimensional space including the one or more input controllers and the wearable integrated device. The right camera is configured to capture a second image of the three-dimensional space including the one or more input controllers and the wearable integrated device. A three-dimensional image of the three-dimensional space may be generated base on the first image and the second image. The image processing unit is configured to identify signal source identities of the first signal emitting unit and the second signal emitting unit, and preprocess the first image and the second image to obtain data indicating the positions of the first signal emitting unit and the second signal emitting unit in the first image and the second image. The communication unit is configured to transmit the data obtained by preprocessing to the wearable integrated device, and the user's interaction within the virtual reality environment can be calculated according to the data.

According to another aspect of the present disclosure, a method for interacting within a virtual reality environment is provided. The method including: capturing, by a binocular camera, a first image of a three-dimensional space by a left camera of the binocular camera, wherein the first image includes one or more input controllers and a wearable integrated device; capturing, by the binocular camera, a second image of a three-dimensional space by a right camera of the binocular camera, wherein the second image includes the one or more input controllers and the wearable integrated device; identifying, by the binocular camera, a first signal emitted by a first signal emitting unit of the input controller, and identifying a second signal emitted by a second signal emitting unit of the wearable integrated device; obtaining the data indicating positions of the first signal emitting unit and the second signal emitting unit in the first image and the second image according to preprocess the first image and the second image; and transmitting the data to the wearable integrated device.

### BRIEF DESCRIPTION OF THE DRAWINGS

In order to make the technical solution described in the embodiments of the present disclosure more clearly, the drawings used for the description of the embodiments will be briefly described. Apparently, the drawings described below are only for illustration but not for limitation. It should be understood that, one skilled in the art may acquire other drawings based on these drawings, without making any inventive work.

FIG. 1 is a schematic diagram of a system that interacts with a virtual reality environment according to an embodiment of the present disclosure.

FIG. 2 is a schematic diagram of a binocular camera according to an embodiment of the present disclosure.

FIG. 3 is a schematic diagram of another system that interacts with a virtual environment according to an embodiment of the present disclosure.

FIG. 4 is a schematic diagram of a handheld controller according to an embodiment of the present disclosure.

FIG. 5 is a schematic diagram of the structure of the signal emitting unit according to an embodiment of the present disclosure.

FIG. 6 is a schematic diagram of a head integrated device of the wearable integrated device according to an embodiment of the present disclosure.

### DETAILED DESCRIPTION

The technical solutions in the embodiments of the present disclosure are described in conjunction with the drawings in the embodiments of the present disclosure. It is obvious that the described embodiments are only a part of the embodiments of the present disclosure, and not all embodiments. All other embodiments obtained by the ordinary skilled in the art based on the embodiments in the present disclosure without the creative work are all within the scope of the present disclosure.

It should be noted that similar reference numerals and letters indicate similar items in the following figures. Therefore, once an item is defined in a drawing, it is not necessary to further define and explain it in the subsequent drawings. Also, in the description of the present disclosure, the terms “first”, “second”, and the like are used merely to distinguish a description, and are not to be construed as indicating or implying a relative importance.

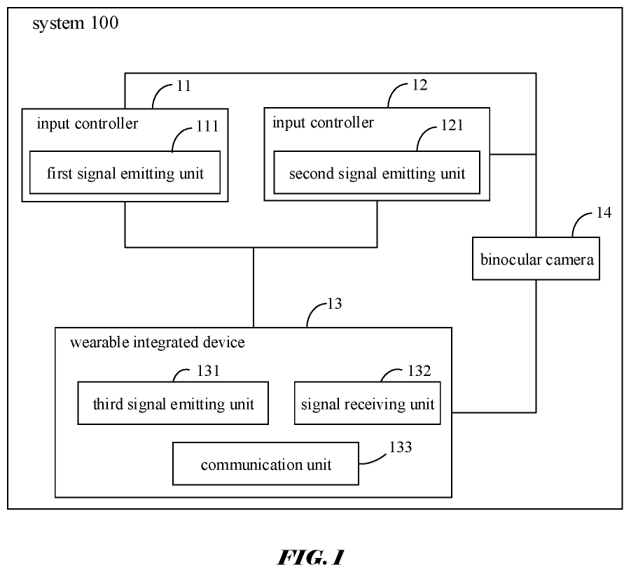

FIG. 1 is a schematic diagram of a system 100 that interacts with a virtual reality environment according to an embodiment of the present disclosure. The system 100 includes separate components: input controllers 11, 12, a wearable integrated device 13 and a binocular camera 14. The input controllers 11, 12 may be configured to interact with the virtual reality environment when user operates in the virtual reality environment. The wearable integrated device 13 can be worn by user, and may be integrated with the mobile device that can run the virtual reality environment. The binocular camera 14 can be disposed apart from the input controller 11, 12 and the wearable integrated device 13 in a distance when the system 100 is used. The input controllers 11, 12, the wearable integrated device 13 and the binocular camera 14 may be connected to each other via wired or wireless communication mode.

The input controller 11 may include a first signal emitting unit 111, and the input controller 12 may include a second signal emitting unit 121. The first signal emitting unit 111 is configured to emit a first signal, and the second signal emitting unit 121 is configured to emit a second signal. The first signal and the second signal can be used to indicate the three-dimensional spatial positions of the input controller 11 and the input controller 12 respectively, which can be captured by the binocular camera 14. For example, the first signal emitting unit 111 may emit a first signal when it is activated or manipulated by user, the second signal emitting unit 121 may emit a second signal when it is activated or manipulated by user. The first signal and the second signal may be the same or different.

The wearable integrated device 13 may be configured to integrate or carry a mobile device capable of operating a virtual reality environment, such as a smart phone, a PAD, or the like. In some embodiments, the mobile device may be a running device for running the virtual reality environment. With the improvement of the processing performance of mobile devices, the mobile device can be fully capable of meeting the processing power requirements of virtual reality systems.

The wearable integrated device 13 may include a third signal emitting unit 131, a signal receiving unit 132, and a communication unit 133. The third signal emitting unit 131 is configured to emit a third signal. The third signal that can be captured by the binocular camera 14 can be used to indicate the three-dimensional spatial position of the wearable integrated device 13. For example, the third signal emitting unit 131 may emit a third signal when it is activated, manipulated, or the input controller 11 or 12 is manipulated by user. The signal receiving unit 132 is configured to receive data transmitted to the wearable integrated device 13, such as the data transmitted from the binocular camera 14, the input controller 11 or 12. The communication unit 133 is configured to transmit the data received by the signal receiving unit 132 to the mobile device mounted on the wearable integrated device 13.

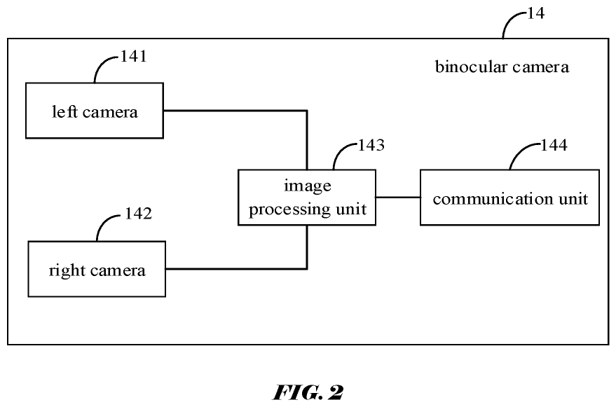

Referring to FIG. 2, the binocular camera 14 may include a left camera 141, a right camera 142, an image processing unit 143, and a communication unit 144. The left camera 141 and the right camera 142 can monitor the three-dimensional space in which the user, wearing the wearable integrated device 13 and using the input controller 11 or 12, is located.

The left camera 141 may be configured to capture a first image of a three-dimensional space including the wearable integrated device 13 and the input controller 11 or 12. The right camera 142 may be configured to capture a second image of the three-dimensional space including the wearable integrated device 13 and the input controller 11 or 12. A three-dimensional image of the three-dimensional space can be generated with the first image captured by the left camera 141 and the second image captured by the right camera 142.

The image processing unit 143 may be connected to the left camera 141 and the right camera 142, and configured to preprocess the first image and the second image captured by the cameras to obtain data indicating the positions of the input controller 11 or 12, and the wearable integrated device 13 in the first image and the second image, specifically, to obtain data indicating the positions of the first signal emitting unit 111, the second signal emitting unit 121, and third signal emitting unit 131 in the first image and the second image, and then the data is transmitted to the communication unit 144 which is connected to the image processing unit 143. The communication unit 144 is configured to transmit the data to the wearable integrated device 13. In addition to the positions of the input controller 11 or 12, and the wearable integrated device 13, the data may further include other information related to the calculation of user's interaction with the virtual reality environment. In one embodiment, the data can be received via the signal receiving unit 132 of the wearable integrated device 13, and transmitted via the signal receiving unit 132 to the mobile device integrated on the wearable integrated device 13. The data can be processed by the processor of the mobile device, and user's interaction with the virtual reality environment can be indicated according to the position represented by the data. For example, a specific object can be abstracted in the virtual reality environment according to the position represented by the data, such as a cursor, a sphere, a cartoon character, can be displayed or moved, which is not limited in the present disclosure. Therefore, the interaction between the user and the virtual reality environment can be calculated or tracked based on the preprocessed data, which is indicated in the change of the coordinate position of the abstracted specific object in the virtual reality environment.

The image processing unit 143 may be further configured to identify the signal source identities of the signal emitting units 111, 121, and 131 according to the received signal. In some embodiments, the signal emitting units 111, 121, and 131 respectively correspond to unique information, so that the identities of the signal emitting units 111, 121, and 131 can be distinguished according to the corresponding unique information when the signal emitting units 111, 121, and 131 coexist in the virtual reality environment. For example, the wavelengths of signals emitted via the signal emitting units 111, 121, and 131 can be different, thus the identities of the signal emitting units 111, 121, and 131 can be distinguished according to different signal sources corresponding to the different wavelengths.

In some embodiments, the data including the positions of the input controllers 11, 12 and the wearable integrated device 13 can be transmitted to the mobile device, and the user's interaction with the virtual reality environment can be based on one or more pairs of the three position data by the mobile device, depending on the virtual reality environment which the mobile device is running. In one embodiment, one or more of the three position data including the input controllers 11, 12 and the wearable integrated device 13 can be transmitted to the wearable integration device 13 by the binocular camera 14, and then can be transmitted to the mobile device running the virtual reality environment by the wearable integrated device 13.

In some embodiments, the input controller may be a handheld controller, the wearable integrated device 13 may be a head mounted integrated device. The cameras 141 and 142 of the binocular camera 14 are constituted by a pair of right and left lenses, the signals emitted from the signal emitting unit which is disposed on the handheld controllers or the head mounted integrated device can be obtained by the cameras 141 and 142. A digital image can be generated by converting the obtained signals into level signals via the cameras 141 and 142, which can be transmitted to the image processing unit 143 to process. In one embodiment, the lens may be a Charge-Coupled Device, or other photosensitive devices, which is not particularly limited in the present disclosure. A pair of images can be generated by capturing signals respectively via the pair of lenses and transmitted to the image processing unit 143 to process at the same time.

In some embodiments, the image processing unit 143 may be a Field Programmable Gate Array (FPGA), a Complex Programmable Logic Device (CPLD), or a single-chip microcomputer, which is not particularly limited in the present disclosure. The result of the image processing by the image processing unit 143 can be transmitted to the device external to the binocular camera 14 via the communication unit 144. In one embodiment, the result of the image processing can be transmitted to the head mounted integrated device 13, and transmitted to a data processing unit of the mobile device detachably mounted on the head integrated device 13 by the head mounted integrated device 13, and finally processed by the data processing unit to complete the calculation of the spatial position.

In some embodiments, the result of the image processing may be transmitted by the communication unit 144 to the head integrated device 13 wirelessly, such as in a 2.4G wireless communication mode, which is not particularly limited in the present disclosure.

It should be noted that, although the input controllers are schematically illustrated as two in FIG. 1, the input controllers may be more than or less than two, which is not limited in the embodiments of the present disclosure. The input controller may be a handheld controller that can be held by a user with both hands or one hand to interact with the virtual reality environment. Alternatively, the input controller may be a foot pedal or similar device that can be used to interact with the virtual reality environment by pedaling or moving it.

The wearable integrated device 13 may be a device integrated with the mobile device that can be worn on the user's head, neck, chest, arms, abdomen, such as a helmet worn on the head. The wearable integrated device 13 may include mechanical components that are easy for user to wear, for example, it can be easily worn on a collar, hat, cuff. The wearable integrated device 13 may further include any suitable components that can integrate a mobile device running the virtual reality environment, such as a clamping structure.

It should be noted that, the components illustrated in FIG. 1 are closely related to embodiments of the present disclosure, the system 100 mentioned above, the input controllers 11, 12, the wearable integrated device 13 and the binoculars camera 14 may further include additional components, respectively. For example, the input controller may further include a processor configured to control the operating state of the input controller, process and transmit internal signals, and the like. The wearable integrated device 13 may further include a processor configured to control operation of the wearable integrated device 13. The binocular camera 14 may further include a bracket configured to support and adjust the height and orientation. In order to illustrate the features of embodiments of the present disclosure more clearly, these possible additional components are not described in above embodiments.

The input controllers 11, 12, the wearable integrated device 13 and the binocular camera 14 can be connected to each other via wired or wireless communication mode. In one embodiment, the input controllers 11, 12 can be connected to the wearable integrated device 13 via USB, and connected to the binocular camera 14 via BLUETOOTH or 2.4G communication techniques, the wearable integrated device 13 can be connected to the binocular camera 14 via BLUETOOTH or 2.4G communication techniques.

In some embodiments, the input controller can be a handheld controller, the wearable integrated device can be a head integrated device integrated with a head mounted display, and the head mounted display can be used as a device configured for displaying the virtual reality environment, the binocular camera can be fixed on a height-adjustable mild steel shelf bracket. A virtual reality environment can be run via a smart phone.

User can hold a handheld controller in each hand, and wear an external head mounted display. The user can stand or sit in front of the binocular camera, and the head integrated device is mounted on the head mounted display. The mobile device (e.g. the smart phone) may be connected to the head mounted display via USB, and a virtual reality system is run on the mobile device, the images of the mobile device can be displayed to the user via the head mounted display. In one embodiment, one or more objects in the environment displayed in the virtual reality system with which the user can operate the handheld controllers to interact, to complete corresponding operation, such as grab, click, move, etc. Therefore, a common use state can be that the user constantly swings the handheld controller in hand.

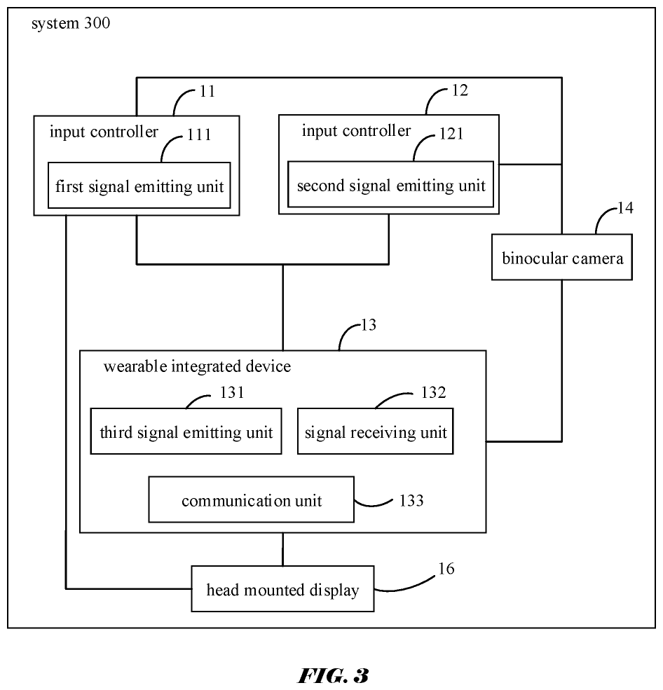

FIG. 3 is a schematic diagram of a system 300 that interacts with a virtual reality environment according to an embodiment of the present disclosure. The system 300 may further include a head mounted display 16, the head mounted display 16 can be used as a display configured for displaying the virtual reality environment, and the wearable integrated device 13 can be disposed on the head mounted display 16. The head mounted display 16 can be connected to the input controllers 11, 12 and the wearable integrated device 130 respectively, via wired or wireless communication mode.

In one embodiment, the wearable integrated device 130 can be a helmet integrated a mobile device, a processor of the mobile device can be configured as a running system of the virtual reality environment, and a screen of the mobile device can be configured as a display of the virtual reality environment.

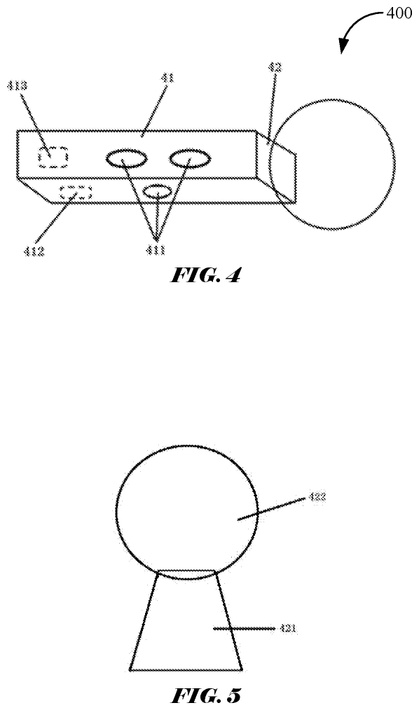

FIG. 4 is a schematic diagram of a handheld controller 400 according to an embodiment of the present disclosure. The handheld controller 400 may include a handle portion 41 and a signal emitting unit 42 disposed at the front end of the handle portion 41. The handle portion 41 includes one or more buttons 411 disposed outside and a processor 412 disposed inside. The processor 412 may be electrically connected to the signal emitting unit 42 and the buttons 411. The buttons 411 can be configured to be manipulated by the user to input an operational signal related to operation of the virtual reality environment, the processor 412 can be configured to process the operation signals and correspondingly control the signal emitting unit 42 to emit light signals for realizing interaction with the virtual reality environment.

The signal emitted from the signal emitting unit 42 of the handheld controller 400 can be captured by the binocular camera 14 for indicating the three-dimensional spatial position of the handheld controller in the virtual reality environment. The coordinate position of the handheld controller 400 (specifically, the signal emitting unit 42 of the handheld controller 400) in the captured image can be obtained by processing the captured image via the binocular camera 14. The coordinate position of the handheld controller in a three-dimensional space can be estimated by using various types of binocular visual 3D measurement algorithms of binocular camera. After the data including the coordinate positions is sent to the processor of the mobile device which is running the virtual reality environment, a virtual object can be abstracted and displayed in the virtual reality environment, according to the coordinate position of the handheld controller 400 by the processor, such as a cursor, a sphere, which is not particularly limited in the present disclosure.

It should be noted that the structure of the handheld controller 400 shown in FIG. 4 is merely illustrative. In one embodiment, the signal emitting unit 42 may be disposed at a portion of the handle portion 41 other than the front end of the handle portion 41. The buttons 411 can be configured to be manipulated by the user to input an operational signal related to the operation of the virtual reality environment for realizing interaction with the virtual reality environment. The buttons 411 can also be replaced with any other suitable operating component, such as a touch screen, a joystick, and the like. In one embodiment, the handle portion 41 may also include other suitable components other than the processor 412, such as a battery module, a communication interface, and the like.

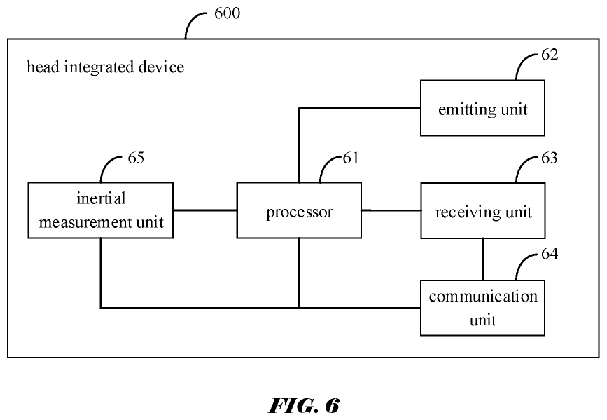

FIG. 5 is a schematic diagram of the structure of the signal emitting unit 42 according to an embodiment of the present disclosure. The signal emitting unit 42 of the handheld controller may include a signal source 421 and a cover 422 covering the signal source 421, the signal source 421 is configured to emit signal that can be captured by the binocular camera 14, and the signal can be emitted to the outside space in a scattering state through the cover 422. In one embodiment, the signal may be a visible light signal, and the signal may be a color signal of the three primary colors, wherein different colors represent the identity of different signal sources. The light signal can be emitted by the signal source 421 in a scattering state via the cover 422 external to the signal source 421. Optionally, the signal is scattered uniformly. The light-emitting volume of the signal source 421 can be increased via the cover 422. The volume of signal source is very small in the visual range of the binocular camera 14 when the signal source 421 is a point source, if the point source is used for image processing, the information captured by the camera will not be enough, which can be avoided with the cover 422.

In some embodiments, the cover 422 may be made of synthetic plastic having shape of memory, and the synthetic plastic can be elastic. The cover 422 may have a specific shape, such as a sphere, an ellipsoid, a sphere, a cube, which is not particularly limited herein. The signal source 421 is covered by the cover 422 entirely, and the signal emitted from the signal source 421 can be scattered uniformly. Therefore, the signal emitting unit 42 of the handheld controller is a light source having a large light-emitting volume relative to the binocular camera 14, and the shape volume of the light source is the shape volume of the cover 422.

In one embodiment, the handheld controller 400 may further include an inertial measurement unit (IMU) 413, which is configured to measure and calculate movement status-related data of the handheld controller, including orientation, trajectory. The inertial measurement unit 413 can be a gyroscope, which is configured to measure the angular rate of the triaxial attitude angle and motion acceleration of the handheld controller 400. The inertial measurement unit 413 is controlled by the processor 412, and the measurement result of the inertial measurement unit can be transmitted to the mobile data processing unit of the mobile device integrated on the wearable integrated device 13 via wired or wireless communication mode, such as BLUETOOTH, Wi-Fi.

The processor 412 of the handheld controller may be configured to control the operational state of the signal emitting unit 42, and process commands entered by the user via the buttons 411. In one embodiment, the buttons 411 are used as an input way for the user to interact with the virtual reality environment, such as select, confirm, cancel, and the like. In one embodiment, a return function can be realized by the buttons 411. The display position of the handheld controller can be returned to an appropriate position by pressing the return button when the display position of the handheld controller in the virtual reality environment is inappropriate. The appropriate position may be a preset position or a position determined by a preset program according to the orientation of the handheld controller at that time.

FIG. 6 is a schematic diagram of a head integrated device 600 of the wearable integrated device 13 according to an embodiment of the present disclosure. The head integrated device 600 includes a processor 61, an emitting unit 62, a receiving unit 63, and a communication unit 64. The processor 61 is electrically connected to the emitting unit 62, the receiving unit 63, and the communication unit 64. The processor 61 is configured to control the running state and logic of the various components within the head integrated device 600, and control the flow of data through the head integrated device 600.

Similar to the signal emitting unit 42 shown in FIG. 4, the emitting unit 62 is configured to emit a signal that can be captured by the binocular camera 14, and the three-dimensional spatial position of the head integrated device 600 in the virtual reality environment can be indicated with the signal. The capturing and processing of the signal by the binocular camera 14 is the same as the capturing and processing of the optical signal emitted from the signal emitting unit 42. Similar to the signal emitting unit 42 shown in FIG. 4, the emitting unit 62 of the head integrated device 600 includes a signal source and a cover having similar structures and functions. The color of the light emitted by the emitting unit 62 of the head integrated device 600 is different from the color of the light emitted by the signal emitting unit 42 of the handheld controller 400, and the different identities of the light sources of the emitting unit 62 and the signal emitting unit 42 can be distinguished.

The receiving unit 63 of the head integrated device 600 is configured to receive the result of image preprocessing (not the final result) transmitted from the communication unit 144 of the binocular camera 14, and transmit the result to the communication unit 64 of the head integrated device 600. The communication unit 64 is connected to a mobile device configured for displaying the virtual reality environment, for example, the communication module 64 is connected to the mobile device via USB. The communication unit 64 is connected to the mobile data processing unit of the mobile device, and the result of image preprocessing can be transmitted to the mobile data processing unit to perform post processing. In one embodiment, the mobile device can be mounted on the head integrated device 600.

In one embodiment, the head integrated device 600 may further include an inertial measurement unit 65, which is configured to measure and calculate movement status-related data of the head integrated device 600, including orientation, trajectory. The inertial measurement unit 65 is controlled by the processor 61 of the head integrated device 600. The measurement result of the inertial measurement unit 65 can be transmitted to the communication unit 64, and can be transmitted by the communication unit 64 to the mobile device connected to the head integrated device 600, and processed by the mobile data processing unit of the mobile device running the virtual reality system. The structure and communication mode of the inertial measurement unit 65 can be the same as the inertial measurement unit 413 of the handheld controller 400 mentioned above, and the detail will not described herein again.

In some embodiments, the information measured by the inertial measurement unit 413 of the handheld controller 400 is transmitted to the mobile data processing unit of the mobile device via BLUETOOTH, and the information measured by the inertial measurement unit 65 of the head integrated device 600 is transmitted to the mobile data processing unit of the mobile device via USB. The spatial three-dimensional coordinate position, orientation, motion trajectory of each signal emitting unit can be calculated by the mobile data processing unit based on the information and parameters of the system that are previously calibrated, and can be used as the spatial position, orientation, and motion trajectory of the corresponding device.

It can be seen from the above description that the data about the motion state of the handheld controller 400 and the head integrated device 600 can be collected in the mobile data processing unit of the mobile device, and the data mainly includes the preprocessing results of the coordinate positions of the signal emitting units (including the handheld controller and the head integrated device) in the image, and the measurement results of the inertial measurement unit (including the handheld controller and the head integrated device). The preprocessing result of the image can be post processed by the mobile data processing unit, and the coordinate position of the signal emitting unit in each image (the images obtained by the binocular camera are paired) can be obtained. Then, the coordinate position of the signal emitting unit in the three-dimensional space can be calculated by the mobile data processing unit based on binocular imaging and calibration results before the system is used.

In some embodiments, when the signal emitting unit is occluded and cannot be imaged in the binocular camera 14, the mobile data processing unit is configured to calculate the motion state and the trajectory of the signal emitting unit by using the physics principle according to the data of the corresponding inertial measurement unit, with the spatial position of the signal emitting unit being occluded as the initial value. Thus, regardless of whether the signal emitting unit is occluded or not, the spatial position of the handheld controller or the head integrated device can be finally calculated by the mobile data processing unit of the mobile device, and the spatial position can be transmitted to the virtual reality system, the corresponding object can be abstracted by the virtual reality system running at the mobile device based on the spatial position and presented to the user. The user can move the object in the virtual reality environment by moving the handheld controller or the head integration device, and the various corresponding functions can be realized by the buttons on the handheld controller, so that the user can interact freely in the virtual reality environment.

The wired connection used in the present disclosure may include, but is not limited to, any one or more of a serial cable connection, a USB, an Ethernet, a CAN bus, and other cable connections, and the wireless connection may include, but is not limited to any one or more of BLUETOOTH, Ultra-Wideband (UMB), WiMax, Long Term Evolution LTE, and future 5G

The embodiments of the present disclosure provide a solution for interacting with a virtual reality environment by dynamically capturing spatial positions of input controllers and a wearable integrated device, generating dynamic data according to the spatial positions, and inputting dynamic data as an input signal to the virtual reality environment to achieve.

The embodiments of the present disclosure have been described in detail above, and the principles and implementations of the present disclosure are described in the specific examples. The description of the above embodiments is only used to help understand the method of the present disclosure and its core ideas. For a person skilled in the art, there will have a change in the specific embodiments and the scope of present disclosure according to the idea of the present disclosure. In summary, the content of the present specification should not be construed as limiting the present disclosure.

What is claimed is:

1. A system for interacting within a virtual reality environment, comprising:
one or more input controllers, configured to interact within the virtual reality environment, wherein the input controller comprises a first signal emitting unit that emits a first signal;
a wearable integrated device, worn by user, integrated a mobile device running the virtual reality environment, comprises:
a second signal emitting unit that emits a second signal;
a signal receiving unit that receives data transmitted to the wearable integrated device; and
a communication unit that transmits the data, received by the signal receiving unit, to the mobile device; and
a binocular camera, disposed apart from the one or more input controllers and the wearable integrated device, comprises:
a left camera, configured to capture a first image of a three-dimensional space including the one or more input controllers and the wearable integrated device;
a right camera, configured to capture a second image of the three-dimensional space including the one or more input controllers and the wearable integrated device;
an image processing unit, configured to identify signal source identities of the first signal emitting unit and the second signal emitting unit, and preprocess the first image and the second image to obtain data indicating the positions of the first signal emitting unit and the second signal emitting unit in the first image and the second image; and
a communication unit, configured to transmit the data to the wearable integrated device,
wherein the user's interaction within the virtual reality environment is calculated according to the data obtained by preprocessing.

2. The system of claim 1, wherein the system further comprises a head mounted display configured to display the virtual reality environment, the wearable integrated device is mounted on the head mounted display.

3. The system of claim 1, wherein the first signal emitting unit comprises one or more first signal sources that emits signals with a fixed-frequency, the second signal emitting unit comprises one or more second signal sources that emits signals with a fixed-frequency.

4. The system of claim 3, wherein the first signal sources and/or the second signal sources emit visible light.

5. The system of claim 3, wherein a cover is disposed outside of the first signal sources or the second signal sources, and configured to form a particular shape signal source.

6. The system of claim 5, wherein the shape of the cover may be a sphere, an ellipsoid, a sphere, or a cube.

7. The system of claim 5, wherein the cover is made of synthetic plastic having shape of memory, and the synthetic plastic is elastic.

8. The system of claim 1, wherein the communication unit of the binocular camera is connected to the wearable integrated device via 2.4G communication mode.

9. The system of claim 1, wherein the input controller further comprises an inertial measurement unit configured to measure and calculate movement status-related data of the handheld controller, including orientation and trajectory; and/or
the wearable integrated device further comprises an inertial measurement unit configured to measure and calculate movement status-related data of the wearable integrated device, including orientation and trajectory.

10. The system of claim 9, wherein the measurement date of the inertial measurement unit of the input controller is transmitted to a mobile data processing unit of the mobile device integrated on the wearable integrated device via wireless communication mode; and/or
the measurement date of the inertial measurement unit of the wearable integrated device may be transmitted to the mobile data processing unit of the mobile device via wired or wireless communication mode.

11. The system of claim 1, wherein the image processing unit is a Field Programmable Gate Array.

12. The system of claim 1, wherein the input controller further comprises an operational portion, configured to be manipulated by user to input an operational signal related to operation of the virtual reality environment.

13. The system of claim 12, wherein the operational portion comprises one or more buttons, touch screens, or joysticks.

14. The system of claim 12, wherein the operational portion further comprises a return portion, configured to realize a return function for returning the position of the user in the virtual reality environment.

15. A method for interacting within a virtual reality environment, comprising:
capturing, by a binocular camera, a first image of a three-dimensional space by a left camera of the binocular camera, wherein the first image includes one or more input controllers and a wearable integrated device,
capturing, by the binocular camera, a second image of a three-dimensional space by a right camera of the binocular camera, wherein the second image includes the one or more input controllers and the wearable integrated device,
identifying, by the binocular camera, a first signal emitted by a first signal emitting unit of the input controller, and identifying a second signal emitted by a second signal emitting unit of the wearable integrated device;
obtaining the data indicating positions of the first signal emitting unit and the second signal emitting unit in the first image and the second image according to preprocess the first image and the second image;
transmitting the data to the wearable integrated device.

16. The method of claim 15, wherein the first signal emitting unit comprises one or more first signal sources that emits signals with a fixed-frequency, the second signal emitting unit comprises one or more second signal sources that emits signals with a fixed-frequency.

17. The method of claim 16, wherein the first signal sources and/or the second signal sources emit visible light.
